(19) United States
(12) Patent Application Publication
(10) Pub. No.: US 2026/0284838 A1
(43) Pub. Date: Sep. 24, 2026

(54) SPANNER WRENCH

(71) Applicant: PTO Solutions LLC, Stafford, TX (US)

(72) Inventors: Dave E. Anderson, Sugar Land, TX (US); Charles Mark Pickle, Sugar Land, TX (US)

(73) Assignee: PTO Solutions LLC, Stafford, TX (US)

(21) Appl. No.: 19/573,436

(22) Filed: Mar. 20, 2026

Related U.S. Application Data
(60) Provisional application No. 63/834,485, filed on Mar. 21, 2025.

(51) Int. Cl. B25B 13/50; B25B 13/48

(52) U.S. Cl. CPC B25B 13/5008; B25B 13/481

(57) ABSTRACT

A spanner wrench adapted to engage a splined shaft comprises a center segment, a first wall extending from the center segment at a first obtuse angle, a second wall extending from the center segment and a second obtuse angle, a first head extending from the first wall, wherein the first head has a first flat and a first hook which define a first pocket adapted to receive the splined shaft and rotate the splined shaft in a first direction, and a second head extending from the second wall. The second head has a second flat and a second hook extending from the second flat which define a second pocket adapted to receive the splined shaft and rotate the splined shaft in a second rection opposite the first direction.

### RELATED APPLICATION

This patent application claims priority benefit of US Provisional Patent Application No. 63/834,485, filed on Mar. 21, 2025.

### FIELD OF THE INVENTION

This invention relates to spanner wrenches, especially spanner wrenches suitable for rotating splined drive shafts such as used for power take off devices.

### BACKGROUND OF THE INVENTION

Agricultural tractors typically use rear-mounted stub output shafts to transfer the rotational energy of the tractor motor to machines or implements connected behind the tractor. The stub output shaft is commonly referred to as a power take off shaft or stub, or sometimes simply a “PTO.” Rear-mounted PTO drive shafts are nestled equidistant between the tractor’s rear tires at the approximate height of the rear axle, and typically have a splined surface. Many implements and other machines connect to agricultural tractors using a three-point hitch or a drawbar. The three-point hitch enables the tractor to elevate the implement off the ground and to operate the tractor in reverse with a connected implement. Examples of these types of three-point hitch mounted implements include rotary cutters, shredders, mowers, tillers, and post hole diggers. In addition, other implements (known as “pull-behind”) attach at the rear of the tractor by a trailer-type drawbar instead of the three-point hitch. Examples of these types of pull-behind implements include flex-wing mowers and balers. All these implements (whether attached by the three-point hitch or drawbar) are examples of those which can be removably connected to the drive shaft of the PTO.

For safety reasons, agricultural tractors have a safety shield around PTO shafts to prevent direct and indirect (via clothing) human contact with the rotating shafts. The safety shield commonly extends beyond the length of the drive shaft and restricts access to the drive shaft. It therefore would be desirable to provide a tool which can easily access the drive shaft of the PTO when it is not in operation.

### SUMMARY OF THE INVENTION

In accordance with a first aspect, a spanner wrench adapted to engage a splined shaft comprising a center segment, a first wall extending from the center segment at a first obtuse angle, a second wall extending from the center segment and a second obtuse angle, a first head extending from the first wall, wherein the first head has a first flat and a first hook which define a first pocket adapted to receive the splined shaft and rotate the splined shaft in a first direction, and a second head extending from the second wall. The second head has a second flat and a second hook extending from the second flat which define a second pocket adapted to receive the splined shaft and rotate the splined shaft in a second direction opposite the first direction.

From the foregoing disclosure and the following more detailed description of various embodiments, it will be apparent to those skilled in the art that the present invention provides a significant advance in the art of spanner wrenches. Particularly significant in this regard is the potential the invention affords for providing spanner wrenches which can be used where access is limited or partially restricted. Additional elements and advantages of various embodiments will be better understood in view of the detailed description provided below.

### BRIEF DESCRIPTION OF THE DRAWINGS

FIG. 1 is a schematic view of a spanner wrench in accordance with one embodiment, shown engaging a splined shaft of a stub removably connectable to a driveline of an implement.

FIG. 2 is an isolated isometric view of the spanner wrench of FIG. 1.

FIG. 3 is a schematic view of the spanner wrench applied to the output shaft of the power take off device which is in turn attached to an implement behind a tractor, shown with a safety shield.

FIG. 4 is a top side view of the spanner wrench of FIG. 1.

FIG. 5 is a side view of the spanner wrench of FIG. 1.

FIG. 6 is a front side view of the spanner wrench of FIG. 1.

FIG. 7 is a rear side view of the spanner wrench of FIG. 1.

It should be understood that the appended drawings are not necessarily to scale, presenting a somewhat simplified representation of various features illustrative of the basic principles of the invention. The specific design features of the elements disclosed here including, for example, the specific dimensions of the spanner wrench opening/pocket adapted to receive the shaft to be rotated clockwise or counterclockwise, will be determined in part by the particular intended application and use environment. Certain features of the illustrated embodiments have been enlarged or distorted relative to others to help provide a clear understanding. In particular, thin features may be thickened, for example, for clarity of illustration. All references to direction and position, unless otherwise indicated, refer to the orientation illustrated in the drawings.

### DETAILED DESCRIPTION OF CERTAIN EMBODIMENTS

It will be apparent to those skilled in the art, that is, to those who have knowledge or experience in this area of technology, that many uses and design variations are possible for the spanner wrench disclosed here. The following detailed discussion of various alternate elements and embodiments will illustrate the general principles of the invention with reference to a spanner wrench suitable for use with a power take off (PTO) shaft. Other embodiments suitable for other applications will be apparent to those skilled in the art given the benefit of this disclosure.

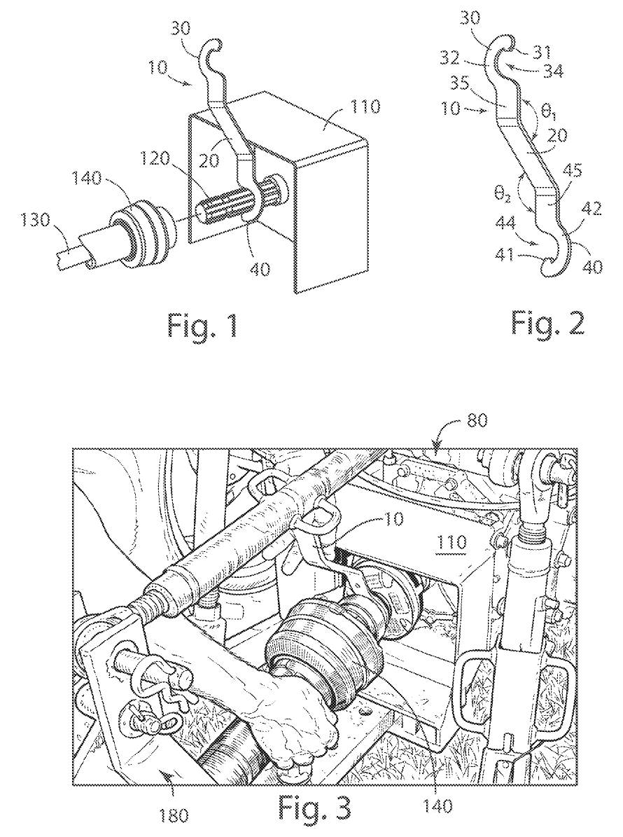

Turning now to the drawings, FIG. 1 shows a PTO 120, preferably having a splined output shaft with exterior splines, as shown. The PTO 120 is operatively engageable to a driveline 130 of an implement which extends toward the tractor. The driveline 130 typically ends in an opening (the female connection) which contains a number of internal splines which are spaced around the interior surface of the opening such that they correspond exactly with the same number of external splines around the exterior surface of the PTO 120 (the male connection). By aligning the internal and external splines with one another, the driveline can be pushed onto the PTO until the driveline is secured via a locking mechanism.

In order to connect the driveline 130 to the PTO 120, the tractor operator must manually elevate the driveline to align with the PTO. The driveline may be telescoping so as to enable the operator to push the female opening towards the PTO. Next, the operator must align the interior splines on the female opening with the exterior splines on the PTO and continue to push the driveline onto the PTO until it can lock into position. The correct alignment of interior and exterior splines may involve slightly rotating the driveline while both supporting its weight and maintaining the correct height. The PTO 120 may be shielded by a safety shield 110, which creates a clearance zone around the PTO and which makes it difficult to access for connection and disconnection. In accordance with a highly advantageous element, spanner wrench 10 is provided to access the drive shaft 120. The spanner wrench has a central segment 20 and at least one head 30 designed to engage and rotate the drive shaft.

FIG. 2 shows an embodiment of the spanner wrench 10 suitable for use in difficult to access locations like the aforementioned. Wrench 10 has the central segment and a pair of heads, preferably a first head 30 and a second head 40, one on each end connected to the central segment by first wall 35 and second wall 45, respectively, as shown. The spanner wrench can be formed from a relatively thin or planar metal and forged or cut or stamped into its final shape. Advantageously the spanner wrench may be bent at a first angle θ1 between the central segment and wall 35, and a second angle θ2 between the central segment and the second wall 45. Preferably both angles θ1 and θ2 are obtuse, such as 135°, and both angles may be the same or different. The effect of each angle is to pivot each head to a location where it is more convenient for the operator to reach the drive shaft with the head for attachment and/or detachment. This convenient alignment can advantageously eliminate the need to remove the safety shield to access the drive shaft. Each head 30, 40 may be provided with a curved flat 32, 42 respectively, which cooperates with a corresponding end 31, 41 to define a corresponding pocket 34, 44. The ends 31, 41 may be hook shaped, allowing for the end to more readily engage the drive shaft. A size of the spanner wrench 10 can vary for the intended use. For example, the spanner wrench can be designed for use with a 6 spline PTO drive shaft that rotates at 540 rpm, or for use with a 21 spline PTO drive shaft that rotates at 1,000 rpm. Other sized spanner wrenches will be readily apparent to those skilled in the art given the benefit of this disclosure.

As shown in FIG. 3, the driveline of an implement is releasably connected to the PTO 120 of a tractor 80. Often the female connection on many drivelines is surrounded by a guard 140, which can be conical shaped. Once the driveline is engaged with the PTO 120 (or, where present, a PTO quick-connect device with an exterior splined shaft), the forward-facing edge of the guard 140 lies within the area protected by the safety shield 110 surrounding the PTO 120, providing the user with a double layer of protection from coming into contact either rotating element. The spanner wrench 10 is adapted to engage the output splined shaft of the stub or the splined shaft of the PTO link device when present.

Proper alignment of the driveline with the PTO is complicated by the safety shield frequently installed around the PTO on at least three sides and the conical shield extending from the driveline. These safety elements impede access to the area around the PTO, thereby limiting the operator’s ability to push the driveline onto the PTO shaft while keeping the two aligned. The operator may also have difficulty aligning the driveline with the PTO drive shaft on implements which cannot freely or easily rotate because the internal gears are belt driven (such as a flail mower), or on the implements with tines or blades that are either heavy, that have some ground interference (such as a tiller or a large flex-wing mower), or that are both heavy and have ground interference.

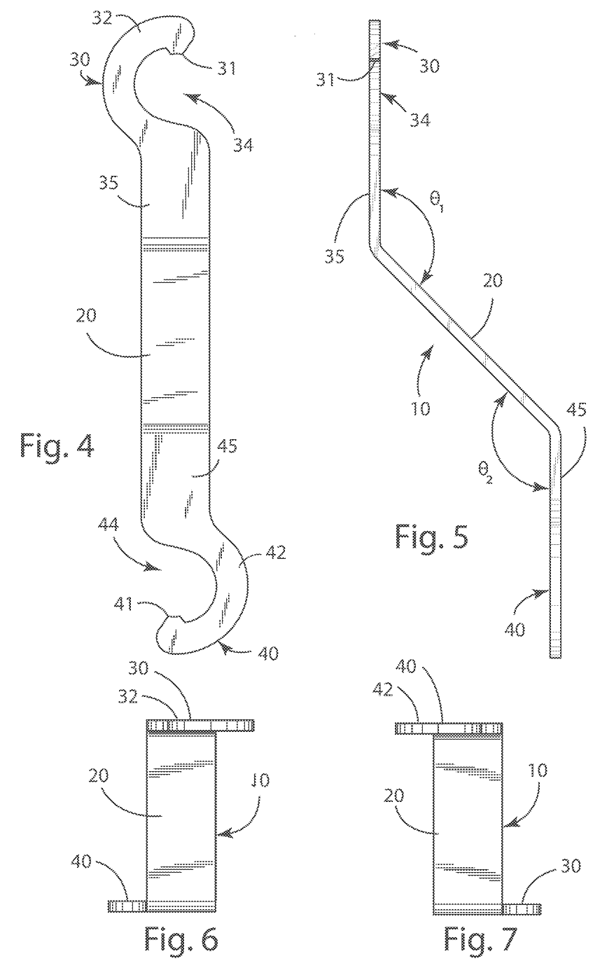

FIGS. 4-7 show several views of the spanner wrench 10. Spanner wrench 10 is provided with the center segment 20 and a first wall 35 extending from the center segment at an angle θ1. However, θ1 is not visible in the view of FIG. 4. Similarly, but visible in FIG. 4, a second wall 45 can extend from the center segment (typically on a side of the center segment opposite the first wall) at an angle θ2. Preferably both θ1 and θ2 are obtuse angles. Optionally both angles may be the same, such as 135 degrees, for example. The spanner wrench can have two heads – first head 30 and second head 40, one of which can be configured to rotate the PTO in a clockwise direction and one of which is configured to rotate the PTO in a counter-clockwise direction. This is highly advantageous since with known wrenches, the user has to walk around to an opposite side of the tractor in order to rotate the PTO drive shaft in the opposite direction. The first head 30 extends from the first wall 35 and defines a first pocket 34 adapted to receive a drive shaft, preferably a splined drive shaft. First hook 31 extends from a first flat 32 and cooperates with the first hook to define the first pocket. In operation, the first hook can engage a splined surface of the drive shaft to allow for rotation of the drive shaft in a first direction, such as clockwise. In a similar manner second head 40 extends from the first wall 45 and defines a second pocket 44 adapted to receive the drive shaft, preferably the splined drive shaft. Second hook 41 extends from the second flat 42 and cooperates the with second flat to define the second pocket 44. In operation, the second hook of the second head can engage the splined surface of the drive shaft to allow for rotation of the drive shaft in a direction opposite the first head (counterclockwise).

Advantageously the angle each wall 35, 45 makes with the center segment 20 serves to offset the corresponding head 30, 40, allowing the spanner wrench to navigate around the tractor’s safety shield (or any other structure generally adjacent to the drive shaft) and in front of the safety shield so as to engage with and rotate the PTO drive shaft to align the splines as needed. In this manner the spanner wrench helps attach the driveline onto the PTO drive shaft. The first hook 31 operatively engages a spline of the splined shaft when the spanner wrench is operatively engaged with the splined shaft. Further, at this time external splines can extend into the first pocket 34 such that rotation of the spanner wrench and the first head 30 rotates the drive shaft in the first direction (clockwise). In a similar manner, when the second hook 41 operatively engages a spline of the splined shaft, the spanner wrench is operatively engaged with the splined shaft. Further at this time, external splines can extend into the second pocket 44 such that rotation of the spanner wrench and the second head 40 rotates the drive shaft in the second direction opposite the first direction (counterclockwise). Thus, a single tool allows for both access to a difficult to reach area and for rotation of the drive shaft in both clockwise and counterclockwise directions. Note that larger spanner wrenches may have additional first hooks on the first head extending into the first pocket and second hooks on the second head extending into the second pocket (such as 2 or 3 hooks on each head), and spaced apart from each other so the plurality of hooks at each head engages multiple adjacent splines of the splined shaft concurrently.

FIG. 5 shows both of the obtuse angles θ1 and θ2, and pocket 34 is visible in this side view, while pocket 44 is not visible. FIG. 5 also shows how the spanner wrench may be formed from generally planar or flat section – center segment 20, first wall 35, first head 30, second wall 45 and second head 40 are all generally flat. If the two angles are the same then the first head and first wall are generally parallel to the second head and second wall. Preferably the spanner wrench is flat from the first wall 35 to the first head 30, and also from the second wall 45 to the second head 40.

Safety shields typically found on tractors limit known wrenches to a very limited range of motion, and typically only at an opening underneath the guard which provides less than a 90° range of motion. Moreover, some tractor safety shields completely encircle the PTO. Due to the obtuse angle offset on the spanner wrenches disclosed herein, the spanner wrench can use the clearance zone created by the safety shield within which to connect to the PTO, potentially offering the wrench a 360° range of motion around the PTO drive shaft.

Spanner wrenches disclosed herein may be used in combination with a PTO quick-connect device, such as the PTO Link® system described in U.S. Patent No. 10,718,383 or U.S. Patent No. 11,313,417. On many tractor models, the PTO is not “freewheeling;” it locks automatically like the steering wheel of a parked car. This adds to the challenge of aligning the PTO drive shaft and the driveline because only the driveline can be turned. Also, in those instances where an implement driveline cannot freely or easily rotate because internal gears are belt driven or the implement’s blades are heavy or have ground interference, the spanner wrench can provide additional leverage to rotate the implement driveline to properly align the splines. Since the implement driveline 130 does not typically have male splines to which the spanner wrench can connect, an implement coupler may be provided with a male spline which is inserted into the female opening of the driveline. This insertion is designed so as to leave a space of access between the coupler’s flange and the conical shield into which the head of the spanner wrench can be inserted to engage with and rotate the driveline in order to complete the alignment and connection with the PTO. The splined shaft the spanner wrench is adapted to engage can be the output shaft of the stub or the splined shaft of the PTO Link® quick-connect device, for example.

By engaging with splines exposed on the PTO, exposed on a PTO quick-connect device, or exposed on the driveline of an implement to be attached to the PTO drive shaft, the spanner wrench assists the user in the clockwise or counterclockwise alignment and rotation needed to attach the implement to the PTO. For those tractors without a freewheeling PTO, the tractor PTO spanner wrench can be used on any exposed splines on the driveline of the implement instead. If, however, the driveline has no exposed splines, the spanner wrench can be used to engage with splines exposed on an ancillary connector to the driveline, such as a PTO quick-connect device. Finally, the spanner wrench can be particularly helpful for challenging implements that need the extra encouragement to rotate for alignment, connection, or disconnection.

From the foregoing disclosure and detailed description of certain embodiments, it will be apparent that various modifications, additions, and other alternative embodiments are possible without departing from the true scope of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A spanner wrench adapted to engage a splined shaft comprising, in combination:
a center segment;
a first wall extending from the center segment at a first obtuse angle;
a second wall extending from the center segment and a second obtuse angle;
a first head extending from the first wall, wherein the first head has a first flat and a first hook which define a first pocket adapted to receive the splined shaft and rotate the splined shaft in a first direction; and
a second head extending from the second wall, wherein the second head has a second flat and a second hook extending from the second flat which define a second pocket adapted to receive the splined shaft and rotate the splined shaft in a second direction opposite the first direction.

2. The spanner wrench of claim 1 wherein the first angle and the second angle are the same.

3. The spanner wrench of claim 1 wherein the first angle and the second angle are 135 degrees.

4. The spanner wrench of claim 1 wherein the first flat and the first wall are coplanar.

5. The spanner wrench of claim 1 wherein the second flat and the second wall are coplanar.

6. The spanner wrench of claim 1 wherein rotation of the first head of the spanner wrench when operatively engaged with the splined shaft rotates the splined shaft in a first direction.

7. The spanner wrench of claim 1 wherein rotation of the second head of the spanner wrench when operatively engaged with the splined shaft rotates the splined shaft in a second direction.

8. A spanner wrench adapted to engage a splined shaft comprising, in combination:
a center segment;
a first wall extending from the center segment at a first obtuse angle;
a second wall extending from the center segment and a second obtuse angle;
a first head extending from the first wall, wherein the first head is coplanar with the first wall and defines a first pocket adapted to receive the splined shaft, and rotation of the spanner wrench rotates the splined shaft in a first direction; and
a second head extending from the second wall, wherein the second head is coplanar with the second wall and defines a second pocket adapted to receive the splined shaft and rotation of the spanner wrench rotates the splined shaft in a second direction opposite the first direction.

9. The spanner wrench of claim 8 wherein a first hook on the first head operatively engages a spline of the splined shaft when the spanner wrench is operatively engaged with the splined shaft such that rotation of the spanner wrench rotates the splined shaft in the first direction.

10. The spanner wrench of claim 9 wherein a second hook on the second head operatively engages a spline of the splined shaft when the spanner wrench is operatively engaged with the splined shaft such that rotation of the spanner wrench rotates the splined shaft in the second direction.

11. The spanner wrench of claim 10 wherein the first head has more than one first hook adapted to engage the splined shaft concurrently, and the second head has more than one second hook adapted to engage the splined shaft concurrently.
